(19) United States
(12) Patent Application Publication
(10) Pub. No.: US 2013/0107052 A1
(43) Pub. Date: May 2, 2013

(54) Driver Assistance Device Having a Visual Representation of Detected Objects

(71) Applicants: Joachim Gloger, Bibertal (DE); Markus Gressmann, Ulm (DE)

(72) Inventors: Joachim Gloger, Bibertal (DE); Markus Gressmann, Ulm (DE)

(73) Assignee: Daimler AG, Stuggart (DE)

(21) Appl. No.: 13/583,336

(22) PCT Filed: Nov. 30, 2010
(86) PCT No.: PCT/EP2010/007233

§ 371 Date: Oct. 9, 2012

(30) Foreign Application Priority Data
Mar. 10, 2010 (DE) 10 2010 010 912.6

(51) Int. Cl. G06K 9/00; H04N 7/18

(52) U.S. Cl. CPC G06K 9/00805; H04N 7/18
USPC 348/148; 382/104

(57) ABSTRACT

Systems and methods for more precisely detecting a position of objects detected in the surroundings of a vehicle with regard to a schematic top view of the vehicle are provided. A driver assistance device for a vehicle includes a sensor device for detecting an object in the surroundings of the vehicle and a display unit for visually representing the object detected by the sensor device with regard to a schematic top view of the vehicle. Ground coordinates of the object as position data can be detected using the sensor device. The ground coordinates are used by the display unit to position a symbol, which symbolizes the object in the top view, in the representation.

### BACKGROUND AND SUMMARY OF THE INVENTION

The present invention relates to a driver assistance device for a vehicle comprising a sensor device for detecting an object in the surroundings of the vehicle and a display unit for visually representing the object detected by the sensor device with regard to a schematic top view of the vehicle.

After an object (here an object is also understood to be a person) has been detected by sensors in/on the vehicle, this information must be conveyed to the driver. This takes place, for example, by means of a so-called surround-view-system, with which the surroundings of the vehicle, including the detected object, are visually represented. Presentation of the “raw detection” is not possible in this case since the detection method usually works with representation of the data different to the presentation system. Therefore, the raw data of the detection method must undergo various pre-processing steps, so that detected objects can be represented in the presentation system. For example, raised objects/persons appear distorted in the bird's-eye perspective of the surround-view-system or they are only partially seen by technically necessary restriction of the visual range.

Such a driver assistance system is disclosed for example by German Patent DE 10 2005 026 458 A1. This driver assistance system surveys a close range of the vehicle by means of an environment sensor system with a plurality of sensors and represents it on a visual display unit. The environment sensor system comprises an evaluating processor unit that determines distance data regarding objects detected at close range of the vehicle by evaluating signals of the sensors also at close range of the vehicle certainly and represents the predetermined distance data as object contours on the visual display unit with respect to a schematic top view of the corresponding vehicle. The distance data are obtained, for example, by measuring the elapsed time. When evaluating the signals the evaluating processor unit only considers the object nearest to the vehicle in one direction. Since only a single value in one direction is detected, it is not always immediately clear in the case of objects having a certain vertical reach where the respective object actually is.

Exemplary embodiments of the present invention are directed to a vehicle assistance system, with which objects detected in the surroundings of a vehicle can be visually represented as precisely as possible in their actual position relative to the vehicle.

According to exemplary embodiments of the present invention a driver assistance device for a vehicle comprises a sensor device for detecting an object in the surroundings of the vehicle and a display unit for visually representing the object detected by the sensor device with regard to a schematic top view of the vehicle. Ground coordinates of the object can be detected as position data by means of the sensor device. The ground coordinates are used by the display unit to position a symbol, which symbolizes the object in the top view, in the representation.

Advantageously a clear position of a detected object can be obtained by acquisition of the ground coordinates. This lateral position relative to the vehicle can be represented in true scale on a display unit, so that the driver can better estimate the actual position of the object and the potential danger resulting therefrom.

Preferably a classification device, which classifies the detected objects according to object classes, is installed upstream to the display unit, so that a detected object can be represented according to its object class with a specific symbol, a specific color, a specific brightness and/or a specific marking. Furthermore, the size of the symbol for the detected object in the representation can depend on the distance of the object to a pre-determined reference point. In addition, the display unit can represent a detected object on the edge of the representation range if its virtual representation position lies outside the representation range.

### BRIEF DESCRIPTION OF THE DRAWING FIGURES

The present invention is now described in detail on the basis of the appended drawings, wherein:

FIG. 1 shows a block diagram of a surround-view-system according to the prior art and

FIG. 2 shows a block diagram of an inventive driver assistance device.

### DETAILED DESCRIPTION

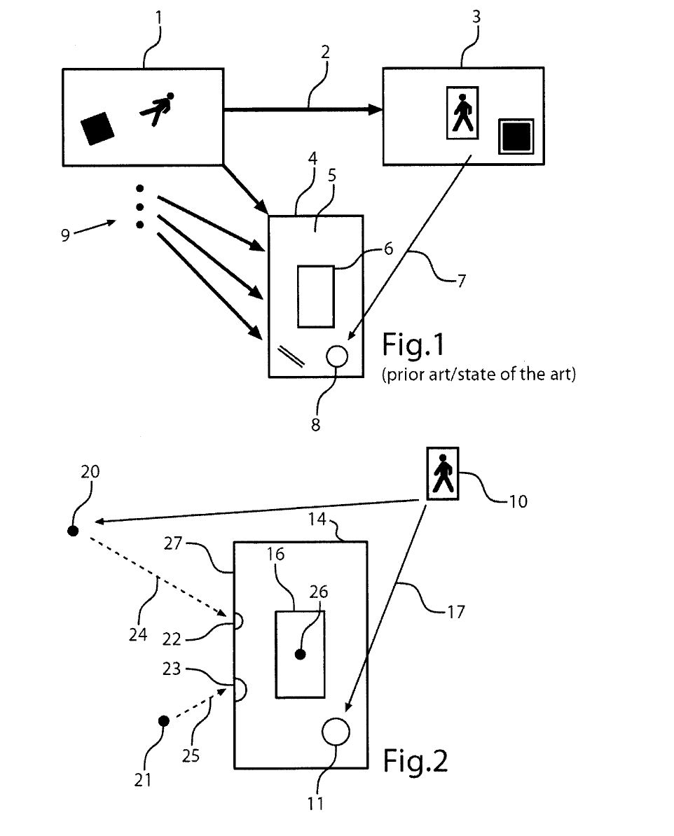

The exemplary embodiments described in detail below represent preferred embodiments of the present invention. First, however, on the basis of FIG. 1 an example from the prior art is described in detail, so that the present invention can be better understood.

The driver assistance system in a well-known embodiment acquires raw data 1. These raw data 1 can be used, for example, to produce a camera gray-scale image. The detected objects are represented in a distorted way therein. It is therefore necessary to subject the raw data to pre-processing 2 so that suitable pre-processed data 3, which are capable of undistorted representation, can be acquired.

In a bird's-eye perspective representation 4 of a display screen integrated into the vehicle, the surroundings 5 of the vehicle are shown including a vertical projection of the vehicle itself onto the ground. Here this vertical projection may be called virtual vehicle 6.

The pre-processed data 3 acquired after pre-processing 2 are used as 2D- or 3D-coordinates 7 of the detected objects for the perspective representation 4. Thus, a symbol 8 for the detected object can be positioned in the perspective representation 4, after corresponding pre-processing has taken place. In order to be able to represent the entire surroundings 5 of the virtual vehicle 6, several photographic images 9 around the vehicle are necessary. These respective photographic images 9 likewise must be pre-processed and their information is used for producing the bird's-eye perspective representation 4.

Since the raised objects cannot be clearly characterized in the method specified above with regard to their position, an inventive method according to the basic representation in FIG. 2 is proposed. Also here a driver assistance system and/or a driver assistance device for a vehicle surveys the surroundings of the vehicle by means of an environment sensor system and represents these on a visual display unit. For this purpose an evaluating processor unit determines position data with respect to a detected object 10 by evaluating signals of the environment sensor system and represents the detected object 10 in the position data as symbol 11 on the visual display unit with regard to a schematic top view 16 of the vehicle, as the result of which a virtual bird's-eye perspective representation 14 of the vehicle surroundings is obtained. In accordance with the invention, ground coordinates (3D-coordinates) of the detected object 10 are determined as position data from the signals of the environment sensor system and projected into the representation 14 with the schematic top view 16 of the vehicle. Preferably, the detected object, in each case depending upon object class, is represented by a superimposed graphic and/or an icon, emphasized by means of color and/or brightness or by marking with colored line segments, as will be described more precisely below.

In detail the 3D-coordinates 17 of the object 10 and/or the person on the ground are determined from the sensor data. For example, the coordinates of the feet of a pedestrian or the underside of a refuse bin are obtained. Thus the position of the object/person can be represented in the bird's-eye perspective, by projecting these (ground) coordinates into the virtual camera used for calculating the bird's-eye perspective. The position in the bird's-eye perspective representation 14 therefore corresponds to the position, at which the object 10 would be perceived by a viewer actually hovering over the vehicle.

If the projected pixel position 20 or 21 lies outside of the representation range of the bird's-eye perspective 14, the representation would take place at the edge of the visual range. The position 22, 23 of the representation at the edge corresponds to the respective intersection of a straight line 24, 25 from the center 26 of the bird's-eye perspective 14 or any other reference point within this perspective and the borders 27 of the representation range 14. The size of the symbol represented at the positions 22 and 23 therefore depends on the distance of the positions 20 and 21 to the reference point 26. If the object is closer to the reference point 26, it is represented at the position 23 with a larger symbol than an object detected at the position 20, which is further away from the reference point 26.

The detected objects can be classified by a classification device. The representation takes place in each case depending upon object class by a superimposed graphic (icon), by emphasizing (color, brightness) of the object or marking with colored line segments. Transparent icons and markings can also be used. Thus, the driver in the bird's-eye perspective representation can recognize how the object, against which he is warned, is constituted. Without transparency the marking would completely or partially conceal the visual range of the detected object.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-5. (canceled)

6. A driver assistance device for a vehicle comprising:
a sensor device configured to detect an object in surroundings of the vehicle; and
a display unit configured to visually represent the object detected by the sensor device with regard to a schematic top view of the vehicle,
wherein the sensor device is further configured to detect ground coordinates of the object as position data, and
wherein the display unit is further configured to use the ground coordinates to position a symbol, which symbolizes the object in the schematic top view, in the visual representation.

7. The driver assistance device according to claim 6, further comprising:
a classification device installed upstream to the display unit, the classification device is configured to classify the detected objects according to object classes, so that a detected object is represented according to its object class with a specific symbol, a specific color, a specific rightness or a specific marking.

8. The driver assistance device according to claim 7, wherein a size of the symbol for the detected object in the visual representation depends on the distance of the object from a pre-determined reference point.

9. The driver assistance device according to claim 6, wherein if a detected object's virtual representation position lies outside of a representation range the display unit is configured to represent the detected object at an edge of the representation range.

10. A method for assisting a driver in a vehicle, comprising:
detecting an object in the surroundings of the vehicle; and
visually representing the detected object with regard to a schematic top view of the vehicle,
wherein ground coordinates of the object are detected as position data and the ground coordinates are used to position a symbol, which symbolizes the object in the schematic top view, in the visual representation.

11. The method according to claim 10, further comprising:
classifying the detected objects according to object classes, so that a detected object is represented according to its object class with a specific symbol, a specific color, a specific rightness or a specific marking.

12. The method according to claim 11, wherein a size of the symbol for the detected object in the visual representation depends on the distance of the object from a predetermined reference point.

13. The method according to claim 10, wherein if a detected object's virtual representation position lies outside of a representation range the display unit is configured to represent the detected object at an edge of the representation range.
